(19) United States
(12) Patent Application Publication
(10) Pub. No.: US 2003/0213838 A1
(43) Pub. Date: Nov. 20, 2003

(54) Craft punch aid

(76) Inventor: Robert Victor Wright, Epping (GB)

Correspondence Address: BROMBERG & SUNSTEIN LLP, 125 SUMMER STREET, BOSTON, MA, 02110-1618, US

(21) Appl. No.: 10/438,284

(22) Filed: May 14, 2003

(30) Foreign Application Priority Data
May 14, 2002 (GB) 0211100.3

(51) Int. Cl. B26F 1/04; B26F 1/14

(52) U.S. Cl. 234/109; 83/684

(57) ABSTRACT

A craft punch aid includes a base portion and a lever portion pivotally attached to the base portion. A rotatable pressure head assembly is attached to the lever portion, the pressure head assembly includes a pressure stub for accommodating punches of differing heights. The base portion may include a pivot device for producing designs of differing radii on a work-piece, and the craft punch aid may include a straight guide for attachment to the base portion for enabling straight-line punching of a work-piece.

### CROSS REFERENCE TO RELATED APPLICATIONS

The present application claims priority from British patent application number GB 0211100.3, filed 14 May 2002, which is incorporated herein by reference.

1. Technical Field

The present invention relates to a craft punch aid of the type which provides leverage to a range of punch sizes while incorporating devices for the guidance of the material.

2. Background Art

Paper punches have become very popular with craft workers and are available in a large variety of sizes and shapes. A punch generally has a die-cast mechanism within a plastic housing. Paper or thin card material is placed into a slot in the punch and a plunger button is pressed down by the fingers to cut a pattern in the material.

In many cases, it is quite hard to push the plunger button on paper, more difficult on card material, and often impossible for those with hand weaknesses such as arthritis or for he disabled. Craft punch aids employ a leverage to reduce the pressure needed to operate the punches.

Craft punch aids made of plastic have to employ a low leverage to withstand use and metal units with greater mechanical advantage suffer from a reduced movement at the pressure point. Therefore such craft punch aids do not readily accommodate the various punch heights without a correspondingly large movement of the handle. Consequently, such craft punch aids are no longer viable in use.

### SUMMARY OF THE INVENTION

In a first embodiment of the invention there is provided a craft punch aid including a base portion and a lever portion. The lever portion is pivotally attached to the base portion and a rotatable pressure head assembly is attached to the lever portion. The pressure head assembly includes a pressure stub for accommodating punches of differing heights. In accordance with related embodiments, the base portion includes a pivot device for producing designs of differing radii on a work-piece. The pivot device may be fixed or adjustable. Further, the pivot device may movalby disposed in a slot in the base portion, the slot having a length, such that the pivot device may be moved along the length of the slot. In accordance with other related embodiments, the craft punch aid may also include a straight guide for attachment to the base portion for enabling straight-line punching of a work-piece, and the straight guide may be adjustable.

In accordance with another embodiment of the invention, a pressure head assembly for a craft punch aid includes a pressure stub and at least one axle disposed through the pressure stub such that rotation of the pressure stub about the axle enables the pressure stub to accommodate punches of different heights. In accordance with related embodiments, the axle may be made of metal. In accordance with further related embodiments, the axle may include two ends and each end may stepped for attachment to a pair of levers. Each stepped end may be provided with a wave spring washer to restrict freedom of rotation of the axle. In accordance with further related embodiments, the pressure stub may be non-metallic.

In accordance with a further embodiment of the invention, a method of craft punching a work-piece includes providing a craft punch aid having a base portion, a lever portion pivotally attached to the base portion and a rotatable pressure head assembly attached to the lever portion. The pressure head assembly includes a pressure stub for accommodating punches of differing heights. The pressure head assembly is rotated depending on the height of the punch used on the work-piece. In accordance with a related embodiment, the base portion of the craft punch aid further comprises a pivot device and the pivot device may be adjusted to produce designs of differing radii on the work-piece. In accordance with another related embodiment, the craft punch aid further comprises a straight guide, the straight guide may be adjusted to permit straight-line punching of the work-piece.

### BRIEF DESCRIPTION OF THE DRAWINGS

The foregoing features of the invention will be more readily understood by reference to the following detailed description, taken with reference to the accompanying drawings, in which:

FIG. 1 is a graphical illustration of a craft punch aid configured with a tall punch in accordance with one embodiment of the present invention;

FIG. 2 is a graphical illustration of the craft punch aid of FIG. 1 configured with a short punch;

FIG. 3 is a graphical illustration of a rotating pressure head assembly in accordance with the embodiment of FIG. 1;

FIG. 4 is a graphical illustration of a craft punch aid with an arc or circle guide in accordance with another embodiment of the invention;

FIG. 5 is a graphical illustration of an adjustable pivot device in accordance with the embodiment of FIG. 4; and

FIG. 6 is a graphical illustration of a craft punch aid with a straight guide in accordance with a further embodiment of the invention.

### DETAILED DESCRIPTION OF SPECIFIC EMBODIMENTS

In accordance with embodiments of the present invention, a craft punch aid includes a rotating pressure head assembly. The ends of a pressure stub are unequal in length and can thus be adjusted to suit short or taller punches readily, while affording great force and allowing a handle of the craft punch to remain in an efficient position during use.

In addition, provision is made for an adjustable, revolving pivot point to allow paper or a card to be decorated in a circular manner under a chosen punch. The adjustment allows a variety of different diameters and radii to be punched, providing a new dimension to punch crafting.

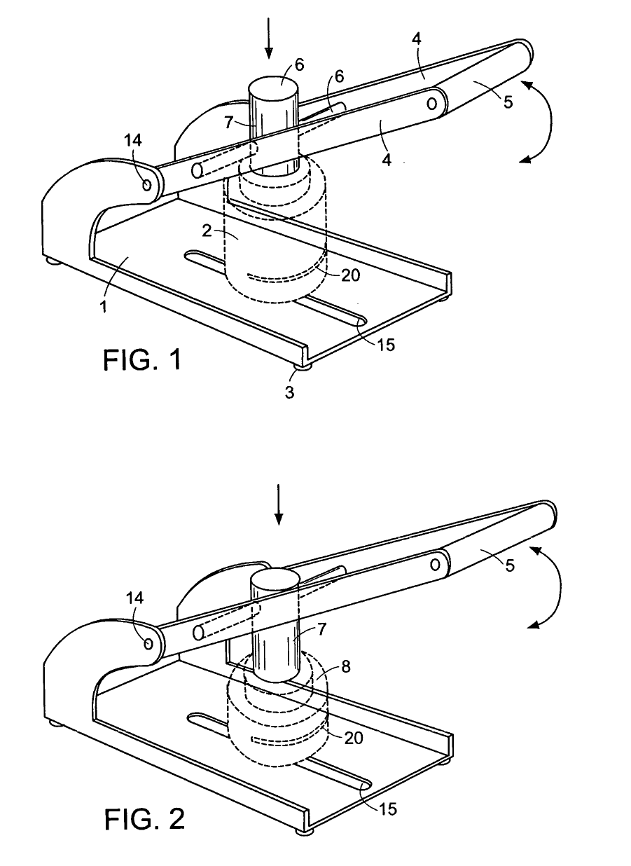

As shown in FIG. 1, a craft punch aid comprises a base 1 to support the selected punch 2 which, in this case, is of the tall variety. Soft feet 3 may be employed to avoid scratching work tops. The levers 4 are pivoted to the base 1 and a block 5 constitutes a handle to the levers 4. A rotating pressure-head assembly 6 is located on the levers 4 at a point to guarantee a high mechanical advantage to the punch 2 when pressing down the handle 5.

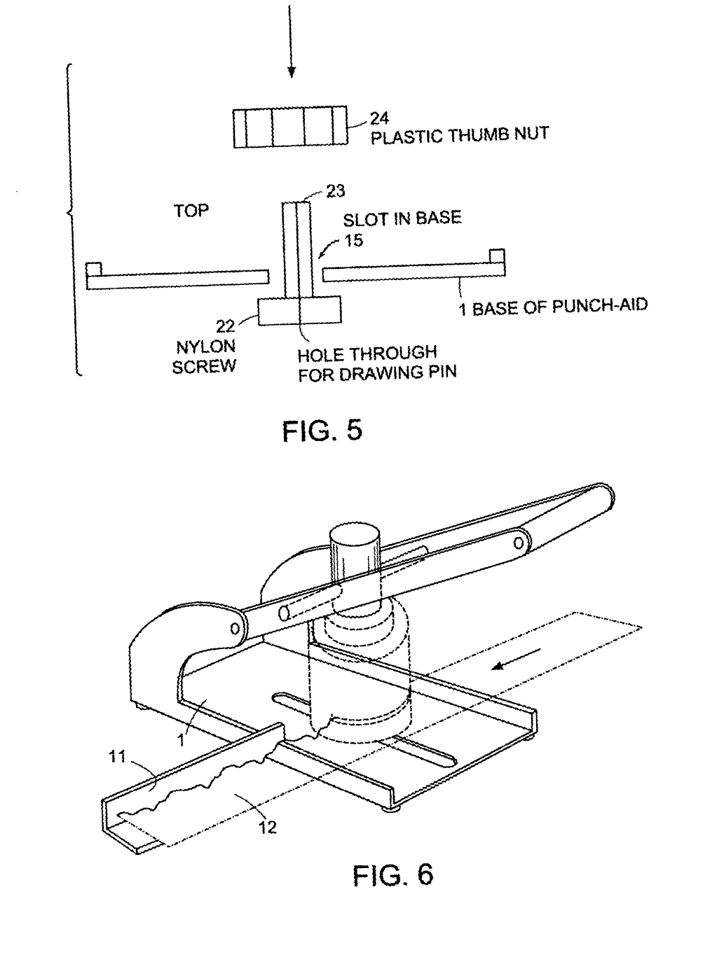

In order to withstand the considerable leverage employed to make the craft punch aid easy to use, metal is used for the base 1 and levers 4. The base 1 comprises a metal tray bent in part to increase the resistance to flexing under pressure and also to form pivot points 14 for the two levers 4. The curved profile of the extended pivot points 14 allows for a paper or card-type work-piece to be fully inserted into the chosen punch. To reduce the generally unwelcome possibility of lateral movement of the punch in use, a rubber mat (not shown) may be bonded to the base under the usual punch positions. To eliminate possible damage to table tops, four rubber feet 3 are bonded under the base 1. The rubber feet 3 also help to prevent the aid slipping on the work top. The base 1 also features a base slot 15 on a center line of the aid to form a track for an adjustable pivot device to be described later with respect to FIGS. 4-5.

The levers 4 include threaded bushes and are attached to the base pivot points 14 with screws and a locking compound to act as axles. The levers 4 are not fully tightened to ensure freedom of movement. Stepped rivets could also be used with fiber washers or other washers as alternative pivots. At one end of the levers 4 a handle 5 is fixed in between. The handle 5 may be cylindrical to afford a good grip that, due to its width, can be used conventionally with the palm of a user's hand or even the user's forearm if the user suffers from arthritis or other weakness of the hands. The open frame effect provided by the use of two levers 4 spaced-apart, affords good vision of the punching process.

FIG. 2 shows the arrangement required for the shorter range of punches 8 by rotation of the unequal length pressure stub 7 to suit the punch, while retaining the handle 5 in a comfortable operating position. In use, the handle 5 is moved to its upright position and a chosen punch 2, 8 is placed on the rubber mat. The handle 5 is lowered and the pressure head assembly is 6 revolved to suit the height of the punch 2, 8 selected. Adjustment of the punch position on the mat may be required to center the punch 2, 8 under the pressure stub 7. With the work-piece inserted into the punch slot 20, the handle is pressed down to cut the punch shape.

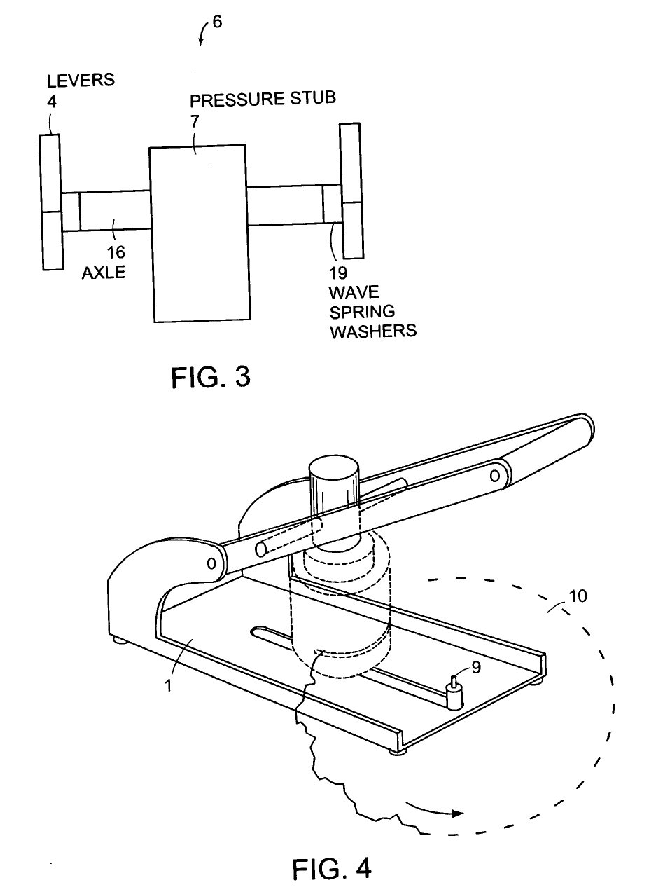

FIG. 3 is a graphical illustration of a rotating pressure head assembly in accordance with an embodiment of the invention. The pressure head assembly 6 is provided with an unequal length pressure stub 7, which may be rotated to suit the higher range of punches while keeping the handle 5 at a comfortable operating position. In order to provide a pressure point to the punch, at least one metal axle 16 is arranged to run transversely between the levers 4. The axle 16 may be stepped at each end and fitted into a hole in each lever 4 close to the base pivot points 14 to affect a high leverage at the pressure point. The pressure stub 7 is forced onto the axle 16 in the center. The pressure stub 7 may be made of nylon or other strong non-metallic material and it presses against plastic punch tops without marking them. The pressure stub 7 is fitted to the axle 16 in such a way that ensures a short end down or a long end down if the axle is revolved through 180 degrees. By this means, tall and shorter varieties of punches 2, 8 can be accommodated while keeping the handle 5 in a reasonable position for the user. A wave-spring washer 19 on the axle at the stepped ends ensures that the axle 16 and pressure stub 7 do not rotate too freely to maintain the last set height position.

Intermediate length stubs may be added to the pressure head assembly to affect an even greater punch height range. Further, although shown here as cylindrical, such that each pressure stub 7 includes two surfaces to contact a punch, the pressure stubs may include several different surfaces of varying lengths to accommodate a variety of punch heights, widths and designs.

As shown in FIG. 4, the base of the aid 1 may be fitted with an adjustable center pivot device 9 to enable a work-piece 10 to be swung under a punch in an arc of desired radius for decorative effect. FIG. 5 is a graphical illustration of an adjustable circle guide in accordance with the embodiment of FIG. 4. The adjustable pivot device 9 is constructed using a nylon screw 22 drilled through to accommodate the stem of a drawing pin 23. The screw 22 is passed through the slot 15 in the base and secured in position by a plastic, threaded knurled nut 24 of low profile. This arrangement ensures that when not in use, no sharp pin is left protruding which may hurt the user. The drawing pin 23 is placed through the work-piece and into the nylon screw/pivot to effect a center point for revolving the work-piece under the chosen punch.

FIG. 6 shows an adjustable straight guide 11 fitted to the base 1 to enable efficient multiple straight-line punching of the work-piece 12. The straight guide 11 may be duplicated on each side of the punch position to improve straight-line feeding of work-piece 12. Marks may also be provided on the guide to enable repeat positioning of the work-piece 12.

Embodiments of the present invention provide efficient leverage to a wide range of punch heights while additionally increasing the versatility of punches by providing features to enable precise location of the work material to decorative effect. Accordingly, such embodiments employ a leverage system fitted with two or more position rotating pressure-heads to allow a comfortable lever position over the range of punch heights. Embodiments of the invention may also employ adjustable guidance features in order to facilitate straight-line or punched arcs to the work-piece.

A craft punch aid as described herein may be made of metal in order to allow higher leverage while ensuring long service life in the hands of the non-mechanically minded, or a combination of metal and plastic for reduced-load bearing components. Levers of the craft punch aid may be spaced apart to allow for a rotating pressure-head device and to increase visibility of the punching process. A device for restraining the punch, such as a non-slip mat, may be positioned under the punch.

Although various exemplary embodiments of the invention have been disclosed, it should be apparent to those skilled in the art that various changes and modifications can be made which will achieve some of the advantages of the invention without departing from the true scope of the invention.

What is claimed is:

1. A craft punch aid comprising:
a base portion;
a lever portion pivotally attached to the base portion; and
a rotatable pressure head assembly attached to the lever portion, the pressure head assembly including a pressure stub for accommodating punches of differing heights.

2. A craft punch aid according to claim 1, wherein the base portion includes a pivot device for producing designs of differing radii on a work-piece.

3. A craft punch aid according to claim 2, wherein the pivot device is adjustable.

4. A craft punch aid according to claim 2, wherein the pivot device is movalby disposed in a slot in the base portion, the slot having a length, such that the pivot device may be moved along the length of the slot.

5. A craft punch aid according to claim 1, further comprising a straight guide for attachment to the base portion for enabling straight-line punching of a work-piece.

6. A craft punch aid according to claim 5, wherein the straight guide is adjustable.

7. A pressure head assembly for a craft punch aid comprising:
a pressure stub; and
at least one axle disposed through the pressure stub such that rotation of the pressure stub about the axle enables the pressure stub to accommodate punches of different heights.

8. A pressure head assembly according to claim 7, wherein the axle is made of metal.

9. A pressure head assembly according to claim 7, wherein the axle includes two ends and each end is stepped for attachment to a pair of levers.

10. A pressure head assembly according to claim 9, further comprising a wave spring washer at each stepped end of the axle to restrict freedom of rotation of the axle.

11. A pressure head assembly according to claim 7, wherein the pressure stub is non-metallic.

12. A method of craft punching a work-piece, the method comprising:
providing a craft punch aid having a base portion, a lever portion pivotally attached to the base portion and a rotatable pressure head assembly attached to the lever portion, the pressure head assembly including a pressure stub for accommodating punches of differing heights; and
rotating the pressure head assembly depending on the height of the punch used on the work-piece.

13. A method according to claim 12, wherein the base portion of the craft punch aid further comprises a pivot device, the method further comprising:
adjusting the pivot device to produce designs of differing radii on the work-piece.

14. A method according to claim 12, wherein the craft punch aid further comprises a straight guide, the method further comprising:
adjusting the straight guide to permit straight-line punching of the work-piece.
